(19) United States
(12) Patent Application Publication
(10) Pub. No.: US 2013/0120902 A1
(43) Pub. Date: May 16, 2013

(54) SUBSTRATE-INCORPORATED CAPACITOR, CAPACITOR-INCORPORATING SUBSTRATE PROVIDED WITH THE SAME, AND METHOD FOR MANUFACTURING SUBSTRATE-INCORPORATED CAPACITOR

(71) Applicants: Hitoshi Noguchi, Kobe-shi (JP); Kenichi Ezaki, Shijonawate-shi (JP)

(72) Inventors: Hitoshi Noguchi, Kobe-shi (JP); Kenichi Ezaki, Shijonawate-shi (JP)

(73) Assignee: SANYO ELECTRIC CO., LTD., Moriguchi-shi, Osaka (JP)

(21) Appl. No.: 13/812,348

(22) PCT Filed: Jul. 7, 2011
(86) PCT No.: PCT/JP2011/065545

§ 371 Date: Jan. 25, 2013

(30) Foreign Application Priority Data
Jul. 30, 2010 (JP) 2010-173037

(51) Int. Cl. H01G 4/232

(52) U.S. Cl. CPC H01G 4/232
USPC 361/303; 29/25.42

(57) ABSTRACT

A substrate-incorporated capacitor includes a first electrode extending in a predetermined direction, a dielectric layer arranged on the first electrode, a second electrode arranged on the dielectric layer and facing the first electrode through the dielectric layer, wherein the second electrode includes an end projecting from the dielectric layer in the predetermined direction, and an electrode layer spaced apart from the first electrode in the predetermined direction. The end of the second electrode is connected to the electrode layer in the predetermined direction. The electrode layer includes a surface that is flush with a surface of the first electrode.

### TECHNICAL FIELD

The present invention relates to a substrate-incorporated capacitor incorporated in a substrate, a capacitor-incorporating substrate including such a substrate-incorporated capacitor, and a method for manufacturing such a substrate-incorporated capacitor.

### BACKGROUND ART

For miniaturized information communications devices, a capacitor may be embedded in a printed circuit substrate, instead of being mounted on the surface of the substrate. A typical substrate-incorporated capacitor that is incorporated in a substrate may have a structure formed by sequentially stacking metal, an insulator, and metal, that is, a structure sandwiching an insulating layer with two electrode layers (refer to, for example, patent document 1).

Patent Document 1: Japanese Laid-Open Patent Publication No. 2006-135036

### SUMMARY OF THE INVENTION

When the capacitor described in patent document 1 is incorporated in a substrate, electrodes, which sandwich a dielectric layer to form the capacitor, are each connected by a single via to a corresponding wire (circuit). More specifically, FIG. 5 of patent document 1 illustrates a lower electrode, which is arranged on a lower surface of a dielectric layer, and an upper electrode, which is arranged on an upper surface the dielectric layer. The lower electrode is electrically connected by a via to a wire arranged below the lower electrode, and the upper electrode is electrically connected by a via to a wire arranged above the upper electrode.

However, in the capacitor described in patent document 1, the wires formed in the same layer, that is, on the same surface, are not electrically connected to a first electrode and a second electrode, which serve as the upper electrode and the lower electrode of the capacitor.

FIG. 11 shows an example of a structure in which wires formed on one surface of a substrate are connected to a first electrode and a second electrode, which form a capacitor incorporated in the substrate.

A substrate 109 shown in FIG. 11 includes a capacitor 101, which is incorporated in the substrate. The capacitor 101 includes a first electrode 110, a dielectric layer 130, which is arranged on the first electrode 110, and a second electrode 120, which is arranged on the dielectric layer 130 at the opposite side of the first electrode 110. A wire 171, which is electrically connected to the first electrode 110, and a wire 172, which is electrically connected to the second electrode 120, are arranged on one surface of the substrate 109.

In the capacitor 101, the second electrode 120, which serves as an upper electrode, is connected by a single via 162 to the wire 172. The first electrode 110, which serves as a lower electrode, is connected by a via 163 to a wire 173, which is arranged at the side opposite to the wire 171. The wire 173 is connected to the wire 171 by a via 161 to connect the first electrode 110 to the wire 171.

More specifically, to connect the wire 171, which is arranged on one surface of the substrate 109, to the first electrode 110 when the capacitor 101 shown in FIG. 11 is incorporated in the substrate 109, the via 161 is formed from one surface of the substrate 109 to the other surface, and the via 163 is formed from the other surface to the first electrode 110. In this structure, the conductive path from the surface of the substrate 109 to the first electrode 110 is long. To improve the impedance characteristics of the substrate of the capacitor-incorporating substrate in a high-frequency range, the conductive path from the surface of the substrate on which the wires are arranged to the electrode should be shortened to reduce inductance that is produced in the capacitor-incorporating substrate.

FIG. 12 shows an example of a capacitor that can connect wires arranged on one surface of a substrate to a first electrode and second electrode without forming vias extending from the surface to the other surface of the substrate.

A capacitor 201 shown in FIG. 12, which is incorporated in a substrate 209, includes a first electrode 210, which is larger than a dielectric layer 230 and a second electrode 220. The second electrode 220, which serves as an upper electrode, is connected by a single via 262 to a wire 272. The first electrode 210, which serves as a lower electrode, is also connected by a single via 261 to a wire 271.

However, as shown in FIG. 12, when the via 261, which is connected to the first electrode 210, and the via 262, which is connected to the second electrode 220, have different lengths, it is difficult to accurately form the vias 261 and 262, which are connected to the first electrode 210 and the second electrode 220. In addition to when the vias 261 and 262 have different lengths, it is difficult to accurately form the vias 261 and 262, which are connected to the first electrode 210 and the second electrode 220, when the first electrode 210 and the second electrode 220 are formed from different materials. More specifically, the formation of vias in the substrate needs to consider, for example, the material that would form the bottom of the vias or the length of the vias to be formed. The formation of vias requires via formation conditions that are suitable for forming the vias connected to the first electrode and the second electrode. Thus, it is difficult to accurately form the vias 261 and 262 shown in FIG. 12.

When the vias, which are to be connected to the first and second electrodes of the substrate-incorporated capacitor, cannot be accurately formed, the vias in the substrate cannot be connected to the first electrode and the second electrode in a satisfactory manner.

Further, in the prior art, the vias formed in the substrate connect the first electrode and second electrode, and the first electrode and second electrode must both be required to have a thickness. This results in an increase in the overall thickness of the capacitor.

Accordingly, it is an object of the present invention to provide a substrate-incorporated capacitor, a capacitor-incorporating substrate, and a method for manufacturing a substrate-incorporated capacitor that can connect vias, which are formed in the substrate, to a first electrode and a second electrode, while reducing thickness.

To achieve the above object, a substrate-incorporated capacitor according to the present invention is characterized by a first electrode extending in a predetermined direction. A dielectric layer is arranged on the first electrode. A second electrode is arranged on the dielectric layer and includes an end facing the first electrode through the dielectric layer and projecting from the dielectric layer in the predetermined direction. An electrode layer is spaced apart from the first electrode in the predetermined direction. The end of the second electrode is connected to the electrode layer in the predetermined direction, and the electrode layer includes a surface that is flush with a surface of the first electrode.

To achieve the above object, a capacitor-incorporating substrate incorporating a substrate-incorporated capacitor according to the present invention is characterized in that the substrate-incorporated capacitor includes a first electrode extending in a predetermined direction. A dielectric layer is arranged on the first electrode. A second electrode is arranged on the dielectric layer and includes an end facing the first electrode through the dielectric layer and projects from the dielectric layer in the predetermined direction. An electrode layer is spaced apart from the first electrode in the predetermined direction. The end of the second electrode is connected to the electrode layer, and the electrode layer and the first electrode are formed from the same material.

To achieve the above object, a method for manufacturing a substrate-incorporated capacitor according to the present invention is characterized by a dielectric layer formation step of forming a dielectric layer on a first electrode. An electrode layer formation step forms a second electrode layer on the dielectric layer. The second electrode layer covers the dielectric layer and is connected to the first electrode layer. An isolation trench formation step forms an isolation trench in the first electrode layer. The isolation trench electrically isolates a part facing the second electrode layer through the dielectric layer and a part connected to the second electrode layer.

The present invention can connect vias to a first electrode and a second electrode of a capacitor in a satisfactory manner when wires arranged on one surface of a substrate are connected by vias to the first electrode and the second electrode.

### BRIEF DESCRIPTION OF THE DRAWINGS

FIG. 1 is a cross-sectional view schematically showing the structure of a substrate-incorporated capacitor according to one embodiment of the present invention and a capacitor-incorporating substrate incorporating the capacitor.

FIG. 2 is a plan view showing the built-in capacitor according to the embodiment.

FIG. 3A is a cross-sectional view and FIG. 3B is a perspective view illustrating a method for manufacturing the substrate-incorporated capacitor according to the embodiment.

FIG. 4A is a cross-sectional view and FIG. 4B is a perspective view illustrating the method for manufacturing the substrate-incorporated capacitor according to the embodiment.

FIG. 5 is a cross-sectional view illustrating the method for manufacturing the substrate-incorporated capacitor according to the embodiment.

FIG. 6A is a cross-sectional view and FIG. 6B is a perspective view illustrating the method for manufacturing the substrate-incorporated capacitor according to the embodiment.

FIG. 7 is a cross-sectional view illustrating the method for manufacturing the substrate-incorporated capacitor according to the embodiment.

FIG. 8 is a cross-sectional view illustrating the method for manufacturing the substrate-incorporated capacitor according to the embodiment.

FIG. 9 is a cross-sectional view illustrating the method for manufacturing the substrate-incorporated capacitor according to the embodiment.

FIG. 10 is a cross-sectional view illustrating a method for manufacturing a substrate-incorporated capacitor according to a second modification of the present invention.

FIG. 11 is a cross-sectional view schematically showing the structure of a substrate-incorporated capacitor of a comparative example and a capacitor-incorporating substrate incorporating the capacitor.

FIG. 12 is a cross-sectional view schematically showing the structure of a substrate-incorporated capacitor of another comparative example and a capacitor-incorporating substrate incorporating the capacitor.

### EMBODIMENTS OF THE INVENTION

One embodiment of the present invention will now be described with reference to the drawings.

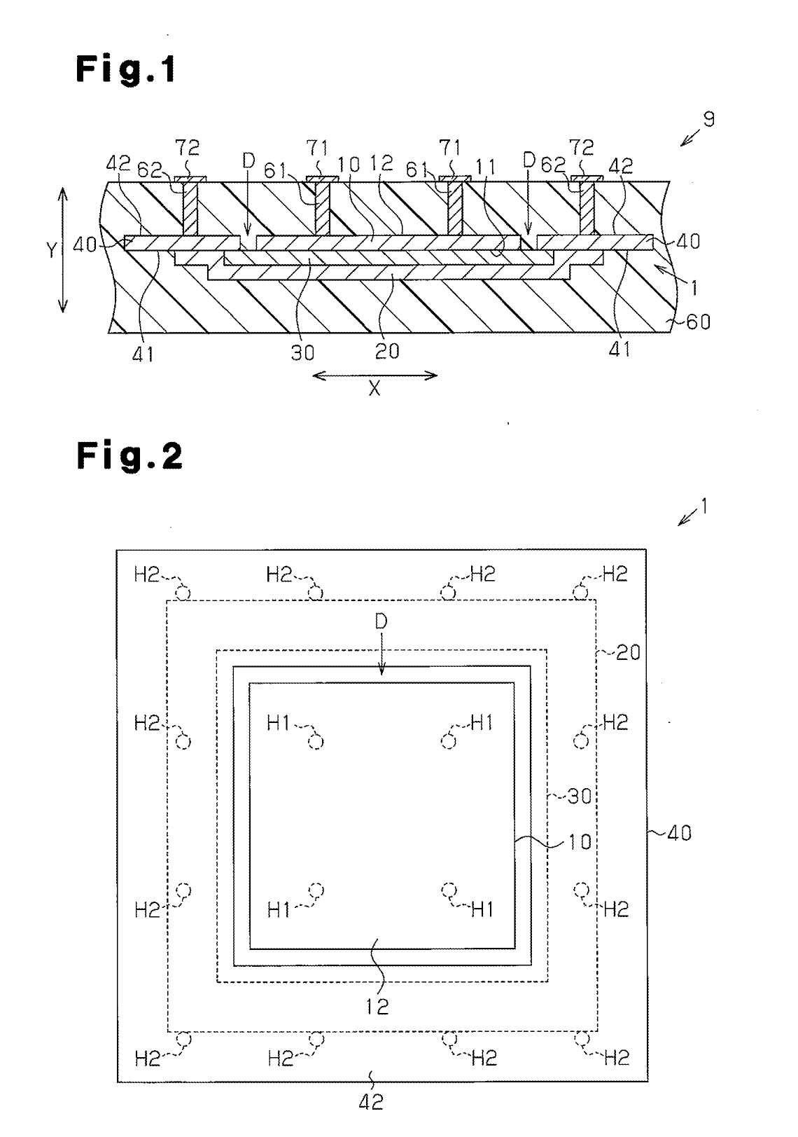

As shown in FIG. 1, a capacitor 1 according to the present invention is a substrate-incorporated capacitor that is incorporated in a substrate 9. In the drawings, arrow X indicates a planar direction X, which is a predetermined linear direction. Further, in the drawings, arrow Y indicates a thickness direction, which is perpendicular to the planar direction X.

The capacitor 1 includes a first electrode 10, a dielectric layer 30, which is arranged on the first electrode 10, a second electrode 20, which is arranged on the dielectric layer 30 at the opposite side of the first electrode 10, and an electrode layer 40, which is connected to the second electrode 20 and flush with the first electrode 10.

As shown in FIG. 2, which is a plan view of the capacitor 1, the first electrode 10, the second electrode 20, and the dielectric layer 30 in the present embodiment are tetragonal. In FIG. 2, portions indicated by broken lines H1 are where vias 61 shown in FIG. 1 are connected. Also, portions indicated by broken lines H2 in FIG. 2 are where vias 62 shown in FIG. 1 are connected.

The first electrode 10, which is made of a conductive material such as metal, is formed from metal foil made of copper, nickel, aluminum, or platinum, or is formed from metal foil made of an alloy of two or more of these metals. As shown in FIG. 1, the first electrode 10, which is thin and flat, includes a surface 11, on which the dielectric layer 30 is arranged, and a surface 12, which is connected o the vias 61. The first electrode 10, which extends in the planar direction X that is a predetermined direction, covers an upper part of the dielectric layer 30 and serves as an upper electrode as shown in FIG. 1.

The second electrode 20, which is made of a conductive material such as metal, is formed from a metal film of copper, nickel, aluminum, or platinum, or is formed from a metal layer of an alloy of two or more of these metals. The second electrode 20, which is a thin film, sandwiches the dielectric layer 30 with the first electrode 10 in the thickness direction Y. The second electrode 20 is larger than the first electrode 10 and the dielectric layer 30 in the planar direction X. The second electrode 20, which extends in the planar direction X, covers a lower part of the dielectric layer 30 and serves as a lower electrode in FIG. 1. Further, the second electrode 20 projects in the planar direction X from two opposite ends of the dielectric layer 30 and covers the two end surfaces of the dielectric layer 30 in the planar direction X. That is, the second electrode 20 includes ends that project from the dielectric layer 30 in the planar direction X, and the ends of the second electrode 20 in the planar direction X are connected to the electrode layer 40.

The dielectric layer 30, which is made of a dielectric material, is made of, for example, oxide ceramics. More specifically, the dielectric layer 30 is made of a metal oxide, such as barium titanate, lithium niobate, lithium borate, lead zirconate titanate, strontium titanate, lead lanthanum zirconate titanate, lithium tantalite, zinc oxide, or tantalum oxide. In addition to the above metal oxide, the dielectric layer 30 may contain additives for improving the dielectric properties. The dielectric layer 30 projects in the planar direction X from two opposite ends of the second electrode 20. The dielectric layer 30, which is arranged on the surface 11 of the first electrode 10, is larger than the first electrode 10 in the planar direction X and projects from the two ends of the first electrode 10 in the planar direction X.

The electrode layer 40, which is made of a conductive material, such as metal, is formed by a metal film, such as a copper film or a nickel film. The electrode layer 40 is formed from the same material as the material of the first electrode 10. The electrode layer 40, which is thin and flat, includes a surface 41, to which the second electrode 20 is connected, and a surface 42, to which the vias 62 are connected. The electrode layer 40, which extends in the planar direction X, is formed to sandwich the two opposite ends of the dielectric layer 30 with the second electrode 20 in the thickness direction Y. Further, the electrode layer 40 is spaced apart from the first electrode 10 in the planar direction X.

In the present embodiment, as shown in FIGS. 1 and 2, a tetragonal frame-shaped isolation trench D is formed between the first electrode 10 and the electrode layer 40. The isolation trench D, which is arranged in an area excluding the periphery of the dielectric layer 30, is defined by the end surfaces of the first electrode 10 and the electrode layer 40 facing one another in the planar direction X and part of the surface of the dielectric layer 30. The surface of the dielectric layer 30 functions as the bottom surface of the trench D.

More specifically, part of the electrode layer 40 covers the ends of the dielectric layer 30 in the planar direction X, and part of the electrode layer 40 faces the second electrode 20 through the dielectric layer 30. The isolation trench D, the bottom surface of which is formed by part of the dielectric layer 30 excluding the periphery, is formed between the electrode layer 40 and the second electrode 20. The isolation trench D electrically isolates the first electrode 10 and the second electrode 20.

In the present embodiment, the first electrode 10 and the electrode layer 40 have the same thickness (dimension in the thickness direction Y). Accordingly, the surface 11 of the first electrode 10 is flush with the surface 41 of the electrode layer 40, and the surface 12 of the first electrode 10 is flush with the surface 42 of the electrode layer 40.

The substrate 9 is a capacitor-incorporating substrate that incorporates the capacitor 1 having the above structure. The substrate 9 includes the capacitor 1 and an insulating substrate 60, which incorporates the capacitor 1. The insulating substrate 60 includes the vias 61, which are electrically connected to the first electrode 10, and the vias 62, which are electrically connected to the second electrode 20. In the present embodiment, the vias 62 are connected to the electrode layer 40 to be electrically connected to the second electrode 20.

A wire 71, which is electrically connected to the first electrode 10, and a wire 72, which is electrically connected to the second electrode 20, are arranged on the insulating substrate 60. The wires 71 and 72 are arranged on one surface of the substrate 9.

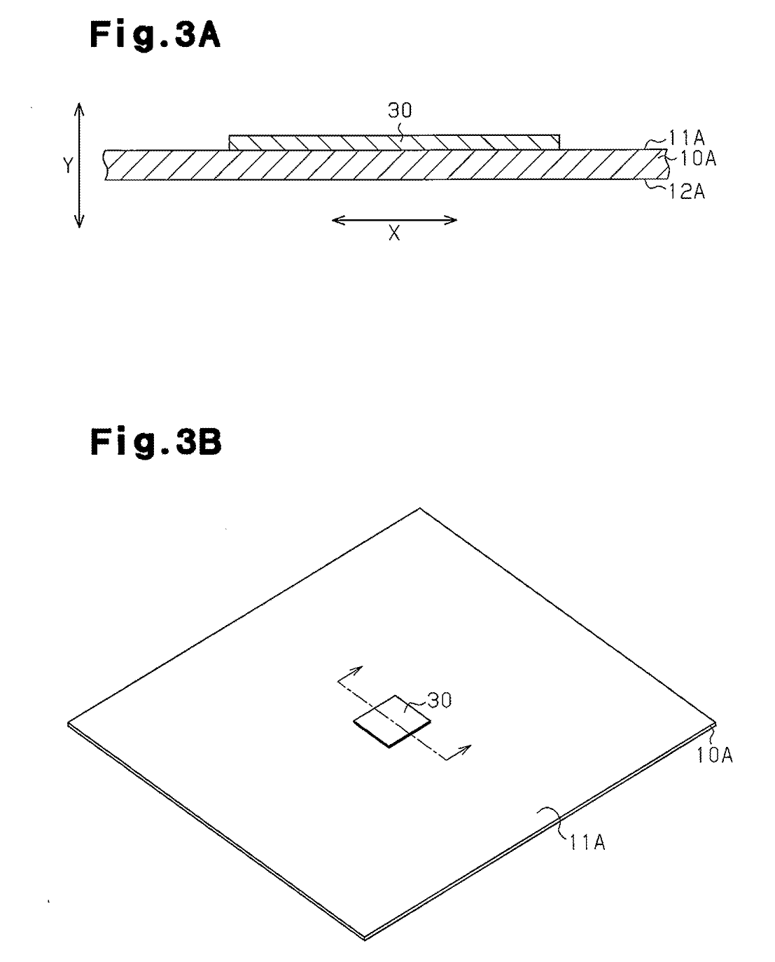

An example of a method for manufacturing the capacitor 1 will now be described with reference to FIGS. 3 to 6. FIGS. 3A, 4A, and 6A are cross-sectional diagrams taken along the single-dashed lines in FIGS. 3B, 4B, and 6B, respectively.

First, a first electrode layer 10A with a predetermined thickness, which allows for easy handling, resists deformation in a subsequent annealing step that will be described later, and has a predetermined thickness, is prepared. The first electrode layer 10A is a metal foil, preferably, copper foil that is highly conductive and easy to obtain.

As shown in FIGS. 3A and 3B, a dielectric layer 30 is formed on part of a surface 11A of the first electrode layer 10A. In other words, the dielectric layer 30 is formed on the first electrode layer 10A (dielectric layer formation step)

In the dielectric layer formation step, the dielectric layer 30 is formed in a powder injection coating process, which injects dielectric powder. Examples of powder injection coating process include aerosol deposition and powder jet deposition. To facilitate the formation the dielectric layer 30 in an atmospheric pressure environment under a normal temperature, the use of powder jet deposition is preferable.

Then, the dielectric layer 30 is annealed to improve its ferroelectric property (annealing step). In the annealing step, the dielectric layer 30 is annealed by, for example, applying laser light to the dielectric layer 30, heating the layer through microwave irradiation, or heating the layer in an annealing furnace.

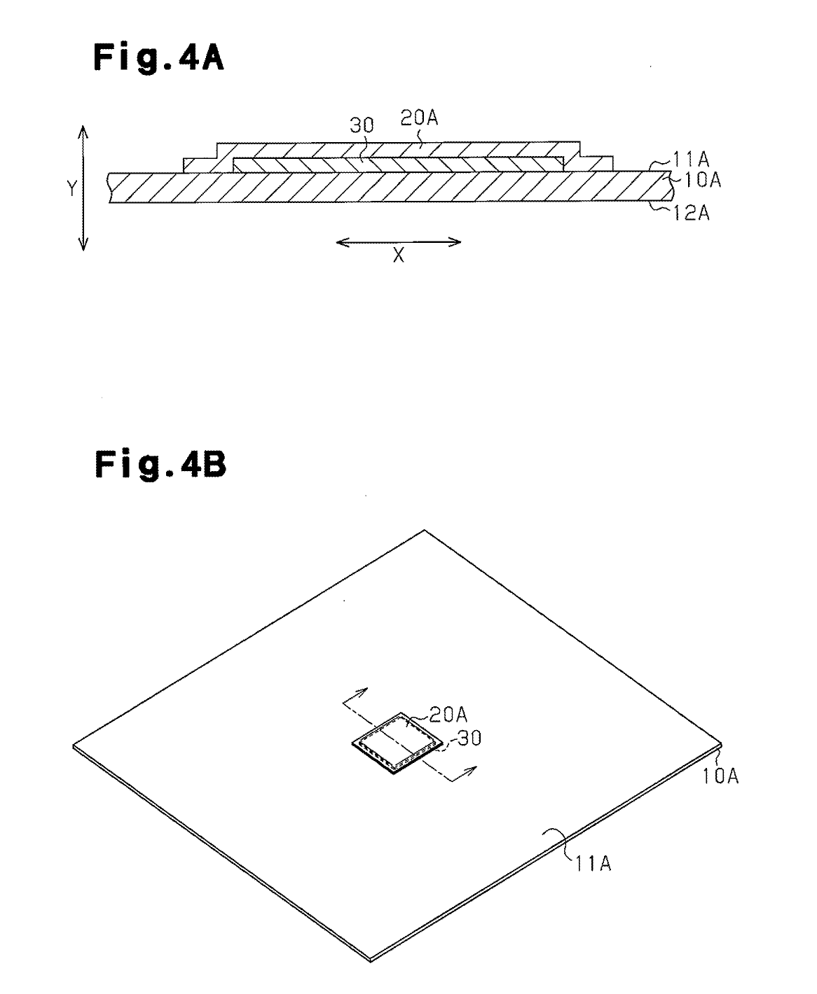

As shown in FIGS. 4A and 4B, a second electrode layer 20A, which is connected to the first electrode 10, is formed covering the dielectric layer 30 (electrode layer formation step). The second electrode layer 20A, which is larger than the dielectric layer 30 in the planar direction X, is arranged on the surface of the dielectric layer 30. The ends of the second electrode layer 20A in the planar direction X are arranged on the surface of the first electrode layer 10A surrounding the dielectric layer 30 and covering the two end surfaces of the dielectric layer 30. The second electrode layer 20A is preferably formed from the same material (i.e., copper) as the first electrode layer 10A although it may be formed from a material that differs from the material of the first electrode layer 10A.

In the electrode layer formation step, the second electrode layer 20A, which is a metal film, is formed by a film formation process such as sputtering, vapor deposition, printing using a conductive paste, plating, or a combination of these processes. The film formation process used in the electrode layer formation step is preferably a process that increases adhesion at the interface of the first electrode layer 10A with the second electrode layer 20A and the second electrode layer 20A.

Then, the first electrode layer 10A, on which the dielectric layer 30 and the second electrode layer 20A are arranged, is reversed (reversing step).

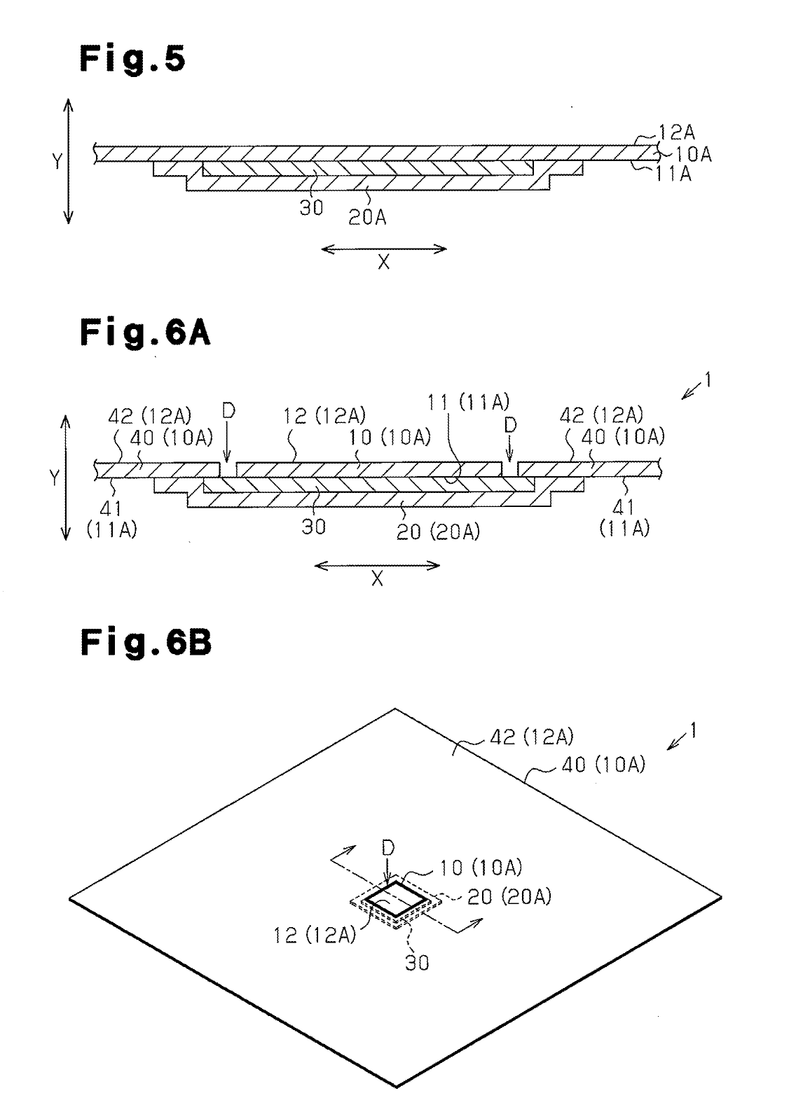

Then, as shown in FIG. 5, the other surface 12A of the first electrode layer 10A opposite to the surface 11A, that is, the surface 12A differing from the surface on which the dielectric layer 30 and the second electrode layer 20A are arranged, is polished to reduce the thickness of the first electrode layer 10A (thinning step). In other words, the dimension of the first electrode layer 10A in the thickness direction Y is reduced uniformly in the planar direction X.

In the present embodiment, the thinning step is an etching process in which the thickness of the first electrode layer 10A is reduced by etching. The etching is chemical polishing that uses a chemical reaction dissolving metal. The etching process may perform dry etching that uses an etching gas or wet etching that uses an etching liquid.

As shown in FIGS. 6A and 6B, the isolation trench D, of which bottom surface is formed by the surface of the dielectric layer 30, is formed in the first electrode layer 10A at a portion excluding the periphery of the dielectric layer 30. More specifically, the isolation trench D is formed in the first electrode layer 10A to electrically isolate the part of the first electrode layer 10A facing the second electrode layer 20A through the dielectric layer 30 from the part of the first electrode layer 10A connected to the second electrode layer 20A (isolation trench formation step).

The formation of the isolation trench D forms the first electrode 10 and the second electrode 20 that are not electrically connected to each other. The isolation of the first electrode layer 10A results in the part facing the second electrode layer 20A through the dielectric layer 30 becoming the first electrode 10, and the second electrode layer 20A becoming the second electrode 20. The part of the first electrode layer 10A connected to the two ends of the second electrode layer 20A forms the electrode layer 40.

More specifically, the isolation trench formation step is an electrode formation process in which the isolation trench D forms the first electrode 10 and the second electrode 20. Thus, the first electrode layer 10A forms the first electrode 10 and the electrode layer 40, and the second electrode layer 20A forms the second electrode 20. Further, the surface 11A of the first electrode layer 10A forms the surfaces 11 and 41 of the first electrode 10 and the electrode layer 40, and the surface 12A of the first electrode layer 10A forms the surfaces 12 and 42 of the first electrode 10 and the electrode layer 40.

As described above, the method for manufacturing the capacitor 1 includes the dielectric layer formation step, the annealing step, the electrode layer formation step, the reversing step, the thinning step (etching process), and the isolation trench formation step. The capacitor 1 is formed through these steps.

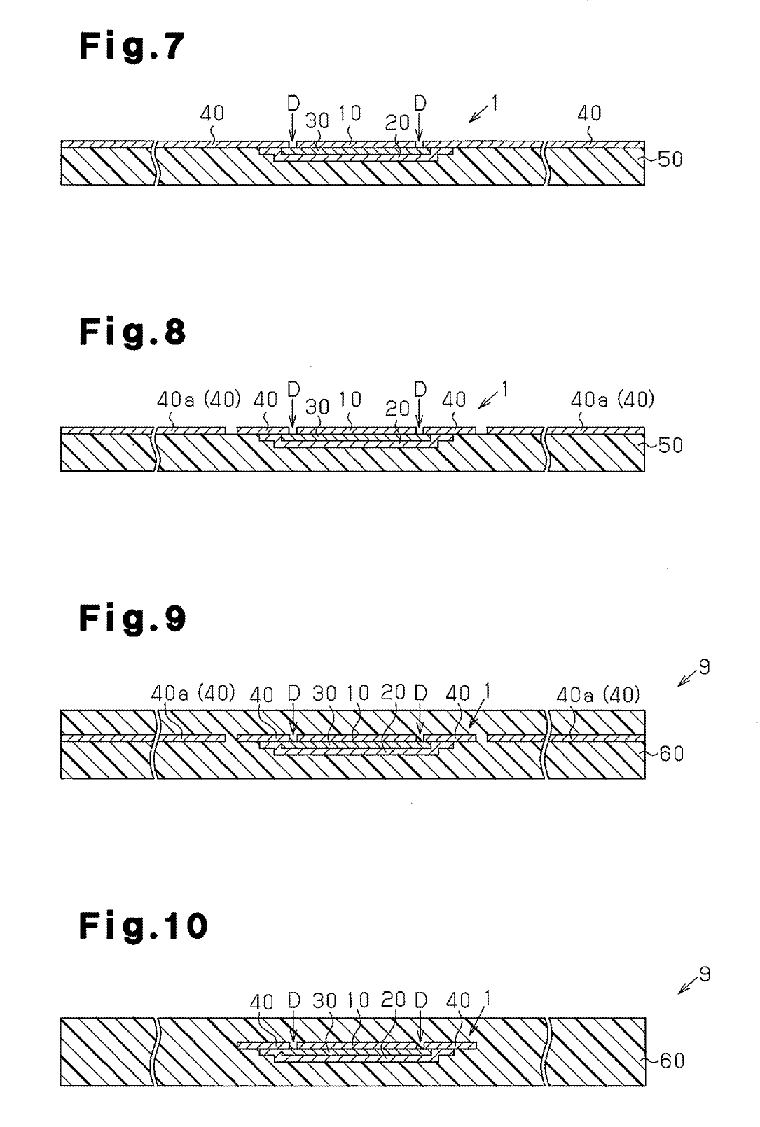

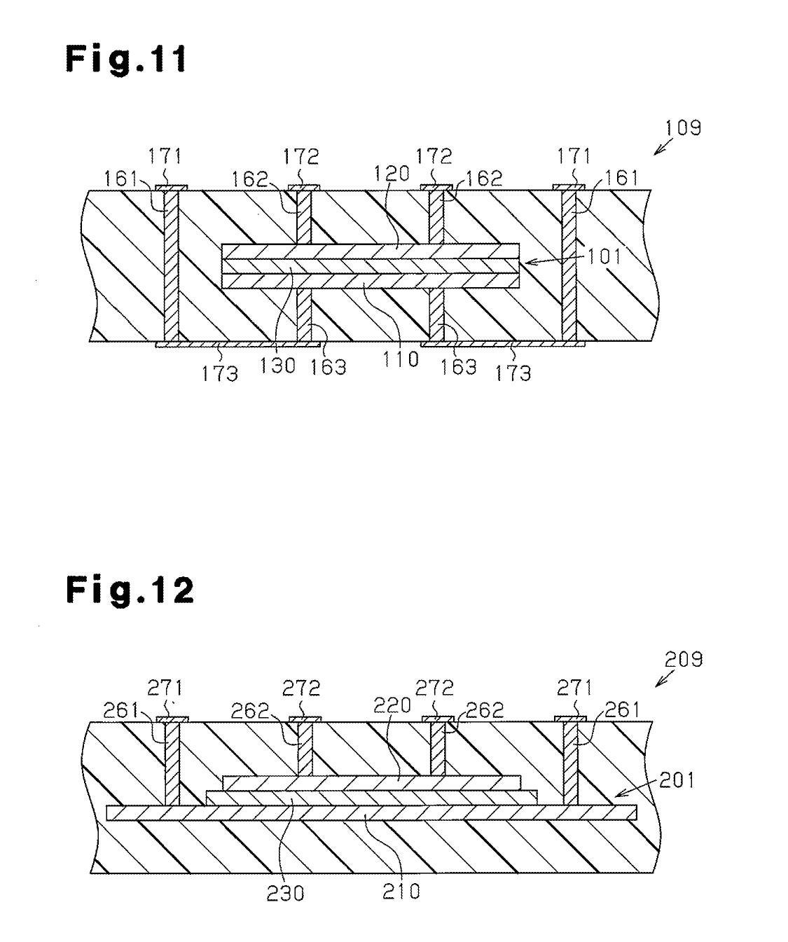

An example of a method for manufacturing the substrate 9 that incorporates the capacitor 1 will now be described with reference to FIGS. 7 to 9.

As shown in FIG. 7, the capacitor 1 is stacked on an insulator 50 (capacitor stacking step). The insulator 50 includes a core and two prepregs sandwiching the core.

In the capacitor stacking step, the insulator 50 is heated and pressurized to pressure-bond the capacitor 1 to the semi-cured prepregs. The insulator 50 may be prepared in advance, and the capacitor 1 may be stacked on the cured prepregs by means of an adhesive (not shown).

As shown in FIG. 8, the electrode layer 40 is etched to form an internal wire 40a (internal wire formation step). More specifically, the electrode layer 40 of the capacitor 1 forms the internal wire 40a, which is arranged in the substrate 9. The internal wire 40a may be a wire that is not connected to the capacitor 1 or a wire that is connected to the first electrode 10.

Then, in the same manner as in the capacitor stacking step, another insulator 50 is heated and pressurized to be stacked on the insulator 50, on which the capacitor 1 is arranged (insulator stacking step). By performing the insulator stacking step, as shown in FIG. 9, the stacked insulators 50 form an insulating substrate 60 and obtains the substrate 9 that incorporates the capacitor 1.

Subsequently, through holes, which function as the vias 61 and 62, are formed in the insulating substrate 60 (via formation step). The wires 71 and 72 are formed on one surface of the insulating substrate 60 (wire formation step).

As described above, the method for manufacturing the substrate 9 includes the capacitor stacking step, the internal wire formation step, the insulator stacking step, the via formation step, and the wire formation step. Through these steps, the substrate 9 shown in FIG. 1 is manufactured.

The above embodiment has the advantages described below.

(1) The capacitor 1 includes the first electrode 10, the dielectric layer 30, the second electrode 20, which faces the first electrode 10 through the dielectric layer 30 and projects from the dielectric layer 30 in the planar direction X, and the electrode layer 40, which is spaced apart from the first electrode 10 in the planar direction X. The ends of the second electrode 20 in the planar direction X are connected to the electrode layer 40. Further, the surface 42, which is the upper surface of the electrode layer 40, is flush with the surface 12, which is the upper surface of the first electrode 10. When the capacitor 1 having this structure is incorporated in the substrate 9, the vias 61 and 62, which extend from one surface of the substrate 9 to the upper surface of the electrode layer 40 and the upper surface of the second electrode 20, are formed in the substrate 9 to connect the wires 71 and 72, which are arranged on one surface of the substrate 9, to the first electrode 10 and the second electrode 20. The connection of the vias 62 to the electrode layer 40 connects the wire 72, which is arranged on one surface of the substrate 9, to the second electrode 20. The direct connection of the vias 61 to the first electrode 10 connects the wire 71, which is arranged on one surface of the substrate 9, to the first electrode 10. In the above structure, the surface 42 of the electrode layer 40 connected to the second electrode 20 is flush with the surface 12 of the first electrode 10. Thus, the vias 61, which are electrically connected to the first electrode 10, and the vias 62, which are electrically connected to the second electrode 20, can have the same length. Accordingly, when the wires 71 and 72, which are arranged on one surface of the substrate 9 are connected to the first electrode 10 and the second electrode 20 through the vias 61 and 62, which are formed in the substrate 9, the vias 61 and 62, which are connected to the first electrode 10 and the second electrode 20, can be formed more easily than when the vias 61 and 62 have different lengths. As a result, the vias 61 and 62, which are formed in the substrate 9, can be connected to the first electrode 10 and the second electrode 20 in a satisfactory manner. Further, when the capacitor 1 having the above structure is incorporated in the substrate 9, there is no need to form vias of which bottom surfaces are defined by the surface of the second electrode 20 as long as the vias 61 and 62 of which bottom surfaces are defined by the surface of the electrode layer 40 and the surface of the first electrode 10 are formed. Thus, there is no need to ensure thickness for the second electrode 20 to form the vias 61 and 62. This avoids increases in the thickness of the second electrode. Accordingly, the thickness of the capacitor 1 can be reduced.

(2) To connect the wire 72 formed on one surface of the substrate 9 to the second electrode 20, the via 62 is formed extending from the surface of the substrate 9 to the surface of the electrode layer 40. This shortens the conductive path from one surface of the substrate 9 to the second electrode 20 in comparison to a structure in which a via is to extend from one surface to the other surface of the substrate 9 and another via is formed to extend from the other surface of the substrate 9 to the second electrode 20. Accordingly, the vias 61 and 62 each have a length corresponding to the shortest distance from the surface of the substrate 9, on which the wires 71 and 72 are arranged, to the capacitor 1. This reduces inductance produced in the substrate 9 and improves the impedance characteristics of the substrate 9 in a high-frequency range.

(3) Part of the electrode layer 40 is arranged on the ends of the dielectric layer 30, part of the electrode layer 40 faces the second electrode 20 through the dielectric layer 30, and the isolation groove D electrically isolating the first electrode 10 and the second electrode 20 is arranged between the electrode layer 40 and the first electrode 10 using part of the dielectric layer 30 excluding the periphery of the dielectric layer 30 as a bottom surface. Thus, the ends of the dielectric layer 30 are sandwiched by part of the electrode layer 40 and the second electrode 20. This prevents the dielectric layer 30 from being delaminated from the first electrode 10 and the electrode layer 40.

(4) When the capacitor 1 is incorporated in the substrate 9, the vias 61 and 62, which extend from one surface of the substrate 9 to the surface 42 of the electrode layer 40 and the surface 12 of the first electrode 10, are formed. The connection of the vias 62 to the electrode layer 40 connects the second electrode 20 and the vias 62, and the direct connection of the vias 61 to the first electrode 10 connects the first electrode 10 and the vias 61. Accordingly, the formation of the electrode layer 40 and the first electrode 10 from the same material allows for the vias 61 and 62, which are connected to the first electrode 10 and the second electrode 20, to be formed more easily than when the subjects to which the vias 61 and 62 are connected are formed from different materials. Further, the vias 61 and 62 can be connected to the first electrode 10 and the second electrode 20 in a more satisfactory manner. Thus, even when the surface 42 of the electrode layer 40 is not completely flush with the surface 12 of the first electrode 10, the vias 61 and 62, which are connected to the first electrode 10 and the second electrode 20, can be easily formed.

(5) The capacitor 1 having the above structure is incorporated in the substrate 9. Thus, the thin substrate 9 can be used as a component incorporated in an electronic device (not shown). As described in advantage (4), when the capacitor 1 is incorporated in the substrate 9, the surface 42 of the electrode layer 40 does not have to be completely flush with the surface 12 of the first electrode 10.

(6) The method for manufacturing the capacitor 1 includes the dielectric layer formation step, which forms the dielectric layer 30, the electrode layer formation step, which forms the second electrode layer 20A covering the dielectric layer 30 and connected to the first electrode layer 10A, and the isolation trench formation step, which forms the isolation trench D electrically isolating the part of the first electrode layer 10A facing the second electrode layer 20A and the part of the first electrode layer 10A connected to the second electrode layer 20A. In this method, the isolation trench D is formed in the first electrode layer 10A, which covers the dielectric layer 30 and is connected to the second electrode layer 20A. As a result, the part of the first electrode layer 10A facing the second electrode layer 20A through the dielectric layer 30 becomes the first electrode 10, and the second electrode layer 20A becomes the second electrode 20. The part of the first electrode layer 10A to which the second electrode layer 20A is connected becomes the electrode layer 40, which is spaced apart from the second electrode 20. In this method, the electrode layer 40 formed through the isolation trench formation step is part of the first electrode layer 10A before the isolation trench formation step, and the electrode layer 40 is arranged in the same manner as the first electrode 10. That is, the surface 42 of the electrode layer 40 connected to the first electrode 10 is flush with the surface 12 of the first electrode 10, and the electrode layer 40 and the first electrode 10 are formed from the same material. This obtains the above-described advantages (1), (2), and (4).

(7) In the isolation trench formation step, the isolation trench D is formed at a portion where its bottom surface is formed by part of the dielectric layer 30 excluding the periphery of the dielectric layer 30. Accordingly, part of the electrode layer 40 is arranged on the ends of the dielectric layer 30, part of the electrode layer 40 faces the second electrode 20 through the dielectric layer 30, part of the electrode layer 40 faces the second electrode 20 through the dielectric layer 30, and the ends of the dielectric layer 30 are sandwiched between part of the electrode layer 40 and the second electrode 20. This obtains the above-described advantage (3).

(8) The method for manufacturing the capacitor 1 includes the thinning step, which reduces the thickness of the first electrode layer 10A, after the dielectric layer formation step. This facilitates handling of the first electrode layer 10A before and when the dielectric layer 30 is formed. Further, in the thinning step, the thickness of the first electrode layer 10A is reduced. Thus, the capacitor 1 can be reduced in thickness (or reduced in height).

(9) The method for manufacturing the capacitor 1 includes the annealing step, which anneals the dielectric layer 30, after the dielectric layer formation step. This improves the ferroelectric property of the dielectric layer 30. When the above thinning step is performed after the annealing step, an oxide film formed on the first electrode layer 10A due to the annealing can be removed in the thinning step. This allows for an increase in the maximum temperature of the annealing step that was set to be low to avoid the formation of an oxide film. Also, when the thinning step is performed after the annealing step, the first electrode layer 10A can have sufficient thickness in the annealing step. As a result, the height of the capacitor 1 can be reduced, while preventing the first electrode layer 10A from being deformed due to the annealing.

(10) In the dielectric layer formation step, the dielectric layer 30 is formed in a powder injection coating process. Thus, the dielectric layer 30 can be formed under a normal temperature through, for example, aerosol deposition or powder jet deposition. As a result, the first electrode layer 10A, which functions as an underlayer, may be formed from a metal having a low melting point.

(11) The thinning step is an etching process that etches and reduces the thickness of the first electrode layer 10A. Thus, the thickness of the first electrode layer 10A can be reduced as desired by performing chemical polishing.

(12) The method for manufacturing the substrate 9 includes the internal wire formation step, which forms the internal wire 40a by etching the electrode layer 10A. Accordingly, the electrode layer 40 of the capacitor 1 can be used as the internal wire 40a arranged in the substrate 9.

The invention is not limited to the above embodiment and may be embodied in many other specific forms without departing from the spirit or scope of the invention. For example, the above embodiment may be modified in the following forms, and the following modifications may be combined with one another.

First Modification

In the capacitor stacking step, the isolation trench D does not have to be formed in the first electrode layer 10A. More specifically, the steps for manufacturing the substrate 9 may include the steps for manufacturing the capacitor 1. In this case, the capacitor 1 and the substrate 9 are manufactured through the steps described below.

The first electrode layer 10A, which is obtained through the dielectric layer formation step, the annealing step, the electrode layer formation step, the reversing step, and the thinning step, is stacked on the surface of the insulator 50, which includes a core and prepregs (electrode layer stacking step).

In the electrode layer stacking step, the insulator 50 is heated and pressurized so that the second electrode layer 20A and the first electrode layer 10A are pressure-bonded to the semi-cured prepregs. The electrode layer formation step obtains the insulator 50 that includes the exposed first electrode layer 10A that is free of the isolation trench D.

Then, in the same manner as in the isolation trench formation step, the isolation trench D is formed in the first electrode layer 10A, which is arranged on the insulator 50 (isolation trench formation step). Subsequently, the internal wire formation step and the insulator stacking step are performed to obtain the substrate 9 shown in FIG. 9. Through the via formation step and the wire formation step, the substrate 9 shown in FIG. 1 is manufactured.

In this modification, the isolation trench formation step, which is the electrode formation step, is performed after the first electrode layer 10A is arranged on the insulator 50 (after the electrode layer stacking step).

The capacitance of the capacitor 1 depends on the area of the part in which the first electrode 10 and the second electrode 20 face each other. Thus, the location at which the isolation trench D is formed relates to the capacitance of the capacitor 1. Accordingly, by performing the isolation trench formation step after the electrode layer stacking step, the capacitor 1 can be obtained with the desired capacitance when manufacturing the substrate 9.

Second Modification

The electrode layer 40 of the capacitor 1 does not have to be used as the internal wire 40a arranged in the substrate 9. More specifically, for example, as shown in FIG. 10, an electrode layer 40, which is smaller in the planar direction X than the electrode layer 40 of the above embodiment, may be used.

In this modification, the capacitor 1 is stacked on the surface of the insulator 50 in the same manner as in the above capacitor stacking step. The substrate 9 that does not include the internal wire 40a is manufactured as shown in FIG. 10 through the insulator stacking step, the via formation step, and the wire formation step. In this case, the internal wire formation step is not performed.

A plurality of dielectric layers 30 may be formed on a single first electrode layer 10A. In this case, after forming the dielectric layers 30, a plurality of dielectric layers 30 may be manufactured from the same first electrode layer 10A by cutting the first electrode layer 10A in conformance with the shape of each dielectric layer 30. This manufactures a plurality of capacitors 1 from a single first electrode layer 10A.

The second electrode 20 may be formed from metal foil made of, for example, copper, nickel, aluminum, or platinum, or from metal foil made of an alloy of two or more of these metals. More specifically, the second electrode layer 20A may be formed from metal foil. In this case, the metal foil may be bonded to the first electrode layer 10A and the dielectric layer 30 in the electrode layer formation step to form the second electrode layer 20A.

The metal foil forming the first electrode layer 10A may be plated. Alternatively, when the second electrode layer 20A is formed from metal foil as described above, the metal foil may be plated.

The thinning step may be performed before the second electrode layer formation step. Further, the thinning step may be performed after the isolation trench formation step.

In the dielectric layer formation step, the dielectric layer 30 may be formed through methods other than powder injection coating process. For example, the dielectric layer 30 may be formed by sputtering, vapor deposition, or a sol-gel process.

The annealing step may be eliminated if the desired ferroelectric property can be obtained.

In the thinning step, the thickness of the first electrode layer 10A may be reduced by methods other than etching. More specifically, the method for reducing the thickness of the first electrode layer 10A is not limited to chemical polishing. For example, mechanical polishing or chemical mechanical polishing may be performed to reduce the thickness of the first electrode layer 10A.

D: isolation trench

X: planar direction

Y: thickness direction

1: substrate-incorporated capacitor

9: capacitor-incorporating substrate

10: first electrode

11, 12: surface

10A: first electrode layer

11A, 12A: surface

20: second electrode

20A: second electrode layer

30: dielectric layer

40: electrode layer

40a: internal wire

41, 42: surface

50: insulator

60: insulating substrate

61, 62: via

71, 72: wire

1. A substrate-incorporated capacitor comprising:
a first electrode extending in a predetermined direction;
a dielectric layer arranged on the first electrode;
a second electrode arranged on the dielectric layer and facing the first electrode through the dielectric layer, wherein the second electrode includes an end projecting from the dielectric layer in the predetermined direction; and
an electrode layer spaced apart from the first electrode in the predetermined direction, wherein the end of the second electrode is connected to the electrode layer in the predetermined direction, and the electrode layer includes a surface that is flush with a surface of the first electrode.

2. The substrate-incorporated capacitor according to claim 1, wherein
part of the electrode layer is arranged on an end of the dielectric layer and faces the second electrode through the dielectric layer, the substrate-incorporated capacitor further comprising
an isolation trench that electrically isolates the first electrode and the second electrode, wherein the isolation trench is arranged between the electrode layer and the first electrode and includes a bottom surface defined by part of the dielectric layer excluding a periphery of the dielectric layer.

3. The substrate-incorporated capacitor according to claim 1, wherein the electrode layer and the first electrode are formed from the same material.

4. The substrate-incorporated capacitor according to claim 2, wherein the electrode layer and the first electrode are formed from the same material.

5. A capacitor-incorporating substrate comprising the substrate-incorporated capacitor according to claim 1.

6. A capacitor-incorporating substrate comprising a substrate-incorporated capacitor, the capacitor-incorporating substrate including:
a first electrode extending in a predetermined direction,
a dielectric layer arranged on the first electrode,
a second electrode arranged on the dielectric layer and facing the first electrode through the dielectric layer, wherein the second electrode includes an end projecting from the dielectric layer in the predetermined direction, and
an electrode layer spaced apart from the first electrode in the predetermined direction,
wherein the end of the second electrode is connected to the electrode layer, and the electrode layer and the first electrode are formed from the same material.

7. A substrate-incorporated capacitor manufacturing method comprising:
forming a dielectric layer on a first electrode;
forming a second electrode layer on the dielectric layer, wherein the second electrode layer covers the dielectric layer and is connected to the first electrode layer; and
forming an isolation trench in the first electrode layer, wherein the isolation trench electrically isolates a part facing the second electrode layer through the dielectric layer and a part connected to the second electrode layer.

8. The substrate-incorporated capacitor manufacturing method according to claim 7, wherein the forming an isolation trench includes forming the isolation trench with a bottom surface defined by part of the dielectric layer excluding a periphery of the dielectric layer.

9. The substrate-incorporated capacitor manufacturing method according to claim 7, comprising reducing a thickness of the first electrode layer after the forming a dielectric layer.

10. The substrate-incorporated capacitor manufacturing method according to claim 8, comprising reducing a thickness of the first electrode layer after the forming a dielectric layer.

11. The substrate-incorporated capacitor manufacturing method according to claim 7, comprising annealing the dielectric layer after the forming a dielectric layer.

12. The substrate-incorporated capacitor manufacturing method according to claim 10, comprising annealing the dielectric layer after the forming a dielectric layer.

13. The substrate-incorporated capacitor manufacturing method according to claim 7, wherein the forming a dielectric layer includes forming the dielectric layer through a powder injection coating process.

14. The substrate-incorporated capacitor manufacturing method according to claim 12, wherein the forming a dielectric layer includes forming the dielectric layer through a powder injection coating process.
